(19) United States
(12) Patent Application Publication
(10) Pub. No.: US 2009/0166576 A1
(43) Pub. Date: Jul. 2, 2009

(54) Flame Retardant Polybutylene Terephthalate Resin Composition

(75) Inventor: Yasumitsu Miyamoto, Shizuoka (JP)

Correspondence Address: BUCHANAN, INGERSOLL & ROONEY PC, POST OFFICE BOX 1404, ALEXANDRIA, VA, 22313-1404, US

(73) Assignee: WinTech Polymer Ltd., Tokyo (JP)

(21) Appl. No.: 12/308,119

(22) PCT Filed: Jun. 19, 2007
(86) PCT No.: PCT/JP2007/062657

§ 371 Date: Dec. 8, 2008

(30) Foreign Application Priority Data
Jul. 14, 2006 (JP) 2006-194662

(51) Int. Cl. C08F 214/16; C08K 5/3492; C08K 5/5313; E04B 1/74

(52) U.S. Cl. 252/62; 524/519; 524/100; 524/133

(57) ABSTRACT

Provided is an insulating material satisfying IEC60695-12 Standard for the molded parts composed of a flame retardant PBT resin composition, specifically for a thin-walled molded article, even without applying secondary working. For details, to (A) 100 parts by weight of a polybutylene terephthalate resin, there are added (B) 5 to 50 parts by weight of a halogen-based flame retardant, (C) 5 to 40 parts by weight of an flame retardant assistant, (D) 5 to 100 parts by weight of a liquid crystalline polymer, and (E) 0 to 200 parts by weight of an inorganic filler.

### TECHNICAL FIELD

The present invention relates to a flame retardant polybutylene terephthalate resin (hereinafter referred also to as “PBT resin”) composition having an improved glow-wire ignition temperature, and to an insulating material part composed of the PBT resin composition.

### BACKGROUND ART

Since the PBT resin has excellent mechanical characteristics, electrical characteristics, heat resistance, weatherability, water resistance, chemical resistance, and solvent resistance, the resin is widely used in various applications as engineering plastics, in automobile parts, electrical and electronic parts, and the like. Although there have been developed many kinds of technologies relating to the improvement in flame retardancy, their reports on achieving the improvement in the flame retardancy, the Comparative Tracking Index (CTI), and other characteristics specified by the UL-94 Standard of Underwriter's Laboratories Inc., and very few reports deal with the IEC60695-2 Standard of International Electrotechnical Commission (IEC). The IEC60695-2 Standard requests the insulating material parts used for electrical and electronic equipment to have durability to ignition and flame propagation during working thereof. Specifically, regarding the equipment parts working without operator, there has been increasing the request for the safety of electrical insulating material part which supports a connection section exceeding 0.2 A of rated current or which is located within 3 mm from the connection section. As a result, it is required to satisfy 850° C. or higher of the glow-wire flammability index (GWFI) and 775° C. or higher of the glow-wire ignition temperature (GWIT) according to the IEC60695-2 Standard. For a thermoplastic resin to satisfy specifically the GWIT standard is very difficult even in materials having V-O in the evaluation of flame retardancy of the UL-94 Standard. Accordingly, there has been increasing the development of flame retardant technology to further improve the conventional technologies in recent years.

As a tendency of actual GWIT evaluations, good result has been obtained at a thickness not allowing the penetration of glow-wire during 30 seconds of contact, (a thickness of 3 mm of fiber-reinforced material, for example), and at a very thin material. In the case of the fiber-reinforced PBT resins, it has been recognized that attaining good evaluation results is the most difficult specifically at thicknesses of 1 to 2 mm.

Since the resin materials under study are not limited in the product thickness in using in the market, and since the products composed of the resin material are expected to have a complex structure with lib and the like, these materials have to satisfy the flammability test over the entire applicable thickness range.

Furthermore, these materials are requested to have, in addition to durability to the flammability test, a good balance of flame retardancy, tracking resistance, and mechanical properties.

As a known method to confer flame retardancy to a PBT resin, there is a composition of a PBT resin with a combination of a halogen-containing flame retardant such as halogenated benzyl acrylate, and of an inorganic flame retardant assistant such as antimony trioxide, further with a specific graft-copolymer, (JP-A 8-109320).

As a flame retardant technology of a thermoplastic resin, there is a known method of the combined use of the thermoplastic resin and a liquid crystalline polymer, (JP-A 3-179051, JP-A 9-31339, and JP-A 10-279821). These publications, however, do not describe GWIT.

Other than the above, according to JP-A 2005-232410, the improvement in GWIT is carried out by an insulating material part which has a resin molded section formed using a resin composition composed of a PBT resin with the addition of polyhalogenated benzyl (meth)acrylate and antimony pentoxide. The insulating material part improves GWIT specified by IEC60695-2-13 Standard at the resin section with a thickness of 2 mm or smaller by combining an insulating plate made of metal or the like. The insulating material part, however, does not satisfy the Standard as a sole PBT resin composition.

### DISCLOSURE OF THE INVENTION

The present invention provides an insulating material for a molded part composed of a flame retardant PBT resin composition, specifically having a thin thickness, satisfying IEC60695-2 Standard without applying secondary working, the molded part having been accepted as difficult to satisfy the Standard.

Furthermore, the present invention provides a resin composition having the above-described characteristics, and further satisfying a good balance between flame retardancy and mechanical properties, thus allowing wide applications in the market.

To achieve the above purpose, the inventors of the present invention have conducted detail study, and have found that a resin composition obtained by blending a PBT resin with a halogen-based flame retardant, a flame retardant assistant, a liquid crystalline polymer, and a fibrous reinforcement improves the durability to glow-wire, and that the addition of a specified amount of flame retardant gives 775° C. or higher of the glow-wire ignition temperature specified by IEC60695-2-13 Standard even at a product thickness of 1.5 mm, the thickness of 1.5 mm having been accepted as specifically difficult to satisfy the Standard, and thus have perfected the present invention.

That is, the present invention provides a flame retardant polybutylene terephthalate resin composition containing: (A) 100 parts by weight of a polybutylene terephthalate resin; (B) 5 to 50 parts by weight of a halogen-based flame retardant; (C) 5 to 40 parts by weight of a flame retardant assistant; (D) 5 to 100 parts by weight of a liquid crystalline polymer; and (E) 0 to 200 parts by weight of an inorganic filler, and preferably further containing (F) 1 to 100 parts by weight of one or more compounds selected from a triazine compound, a phosphinic acid salt, and a diphosphinic acid salt (to 100 parts by weight of the (A) component). Furthermore, the present invention provides an insulating material part composed of the above-mentioned polybutylene terephthalate resin composition.

The polybutylene terephthalate resin composition according to the present invention can provide an insulating material part (printed circuit board, terminal table, plug, and the like) having excellent moldability and assembly characteristics, and improves the safety of insulating material part which supports a connection section exceeding 0.2 A of rated current or which is located within 3 mm from the connection section, thereby allowing wide applications.

### DETAILED DESCRIPTION OF THE INVENTION

The present invention is described in detail in the following. The PBT resin composition according to the present invention is composed of (A) a polybutylene terephthalate resin, (B) a halogen-based flame retardant, (C) a flame retardant assistant, and (D) a liquid crystalline polymer. It is preferable to add (E) an inorganic filler, more preferable to add (F) one or more compounds selected from a triazine compound, a phosphinic acid salt, and a diphosphinic acid salt.

### ((A) PBT Resin)

The (A) PBT resin according to the present invention is a thermoplastic resin obtained by polycondensation of terephthalic acid or an ester-forming derivative thereof with an alkylene glycol (1,4-butanediol) having 4 carbon atoms or an ester-forming derivative thereof, and the thermoplastic resin may be a copolymer containing 70% by weight or larger repeating unit of butylene terephthalate.

The dibasic acid components other than terephthalic acid or an ester-forming derivative thereof (such as lower alcohol ester) include: an aliphatic or aromatic polybasic acid such as isophthalic acid, naphthalene dicarboxylate, adipic acid, sebacic acid, trimellitic acid or succinic acid or an ester-forming derivative thereof. The glycol components other than 1,4-butanediol include: a normal alkylene glycol such as ethylene glycol, diethylene glycol, propylene glycol, trimethylene glycol, hexamethylene glycol, neopentyl glycol, or cyclohexane dimethanol; a lower alkylene glycol such as 1,3-octane diol; an aromatic alcohol such as bisphenol A or 4,4′-dihydroxybiphenyl; an alcohol with alkylene oxide additive such as bisphenol A with ethylene oxide 2-mole additive or bisphenol A with propylene oxide 3-mole additive; and a polyhydroxy compound such as glycerin or pentaerythritol, and an ester-forming derivative thereof. According to the present invention, any of the PBT resins obtained by polycondensation of any of the above compounds as the monomer can be used as the (A) component of the present invention, and can be used either alone or two or more thereof as a mixture.

The (A) PBT resin according to the present invention uses o-chlorophenol as the solvent, and has the intrinsic viscosity within the range of 0.6 to 1.2 g/dl, determined at 25° C., preferably 0.65 to 1.1 g/dl, and more preferably 0.65 to 0.9 g/dl. If the intrinsic viscosity is smaller than 0.6 g/dl, the amount of generated gas as the source of PBT resin such as tetrahydrofuran is not fully decreased, and false appearance, adhesion of deposit, and the like are generated at the time of molding, which is not preferred. If the intrinsic viscosity is larger than 1.2 g/dl, the flowability at the time of molding may become insufficient.

As the PBT resin according to the present invention, a branched polymer which belongs to copolymer can also be used. The PBT resin branched polymer referred to herein signifies what is called the PBT resin or a polyester prepared by branch formation through the addition of a polyfunctional compound to butylene terephthalate monomer as the main component. The applicable polyfunctional compounds include trimesic acid, trimellitic acid, pyromellitic acid, and alcohol ester thereof, glycerin, trimethylol ethane, trimethylol propane, and pentaerythritol.

### ((B) Halogen-Based Flame Retardant)

The (B) halogen-based flame retardant is an essential component for maintaining and improving the flame retardancy. Preferred (B) halogen-based flame retardant includes a halogenated aromatic bisimide compound, a halogenated benzyl acrylate, a halogenated polystyrene compound, or a terminal-modified halogenated aromatic epoxy compound, from the standpoint of improving the effect of GWIT.

The combined use of a commonly used halogenated polycarbonate with a (F) component (described later), as the halogen-based flame retardant, is not preferable because the retention stability at the time kneading or molding deteriorates to give rise to the phenomena such as gas generation and viscosity decrease, though there appears an effectiveness in the GWIT performance.

As the combined use of a halogenated aromatic epoxy compound with a (F) component (described later) causes the increase in viscosity at the time kneading or molding to deteriorate the productivity, there is a need to select a halogenated aromatic epoxy compound in which the epoxy terminal is modified.

Based on the above findings, a halogenated aromatic bisimide compound, a halogenated benzyl acrylate, and a halogenated polystyrene compound are preferable as the halogen-based flame retardants.

The halogen atom includes fluorine, chlorine, bromine, and iodine, and preferable ones are chlorine and bromine.

The (B) halogen-based flame retardant can be used either alone or in combination of two or more of them. The additive amount of the (B) halogen-based flame retardant is within the range of 5 to 50 parts by weight to 100 parts by weight of the (A) PBT resin, preferably 10 to 40 parts by weight, and more preferably 15 to 40 parts by weight. If the additive amount of the (B) halogen-based flame retardant is smaller than 5 parts by weight, sufficient flame retardancy cannot be attained. If the additive amount thereof is larger than 50 parts by weight, mechanical characteristics likely deteriorate.

### ((C) Flame Retardant Assistant)

Applicable (C) flame retardant assistants include an antimony compound such as antimony trioxide or antimony pentoxide known to give synergy effects of flame retardancy when combined with the (B) halogen-based flame retardant; a silicate such as talc or mica; calcium carbonate; magnesium hydroxide; boehmite; zinc sulfide; zinc oxide, and the like. Among these, an antimony compound is preferred.

The additive amount of the (C) flame retardant assistant is within the range of 5 to 40 parts by weight to 100 parts by weight of the (A) PBT resin, preferably from 10 to 30 parts by weight, and more preferably from 15 to 30 parts by weight. If the additive amount of the (C) flame retardant assistant is smaller than 5 parts by weight, the effect as the flame retardant assistant cannot be attained. If the additive amount thereof is larger than 40 parts by weight, mechanical characteristics likely deteriorate.

### ((D) Liquid Crystalline Polymer)

The (D) liquid crystalline polymer according to the present invention signifies a melt-processable polymer which has the property of being able to form an optically anisotropic molten phase. The property of the anisotropic molten phase can be confirmed by a common polarization inspection method utilizing orthogonal polarizers. More specifically, the confirmation of anisotropic molten phase can be done by observing a molten sample on a Leitz hot stage in a Leitz polarization microscope at 40-fold magnification under a nitrogen atmosphere. The liquid crystalline polymer applicable to the present invention allows the polarized light normally to penetrate there even if it is in a molten quiescent state when inspected between the orthogonal polarizers, thus exhibiting optical anisotropy.

The liquid crystalline polymer as described above is not specifically limited, and preferred one is aromatic polyester or aromatic polyester amide. A polyester containing aromatic polyester or aromatic polyester amide within the same molecular chain in a part is also the applicable one. Applicable liquid crystalline polymers have a logarithmic viscosity (IV) of preferably at least about 2.0 dl/g, more preferably from 2.0 to 10.0 dl/g, determined by dissolving the liquid crystalline polymer in pentafluorophenol at 60° C. by 0.1% by weight.

Specifically preferred aromatic polyester or aromatic polyester amide as the (D) liquid crystalline polymer applicable to the present invention includes an aromatic polyester and an aromatic polyester amide, containing at least one compound selected from an aromatic hydroxycarboxycarboxylic acid, an aromatic hydroxyamine, and an aromatic diamine as the structural component.

More specifically, there are applicable:

(1) a polyester composed mainly one, two or more of an aromatic hydroxycarboxylic acid and a derivative thereof;
(2) a polyester composed mainly of (a) one, two or more of an aromatic hydroxycarboxylic acid and a derivative thereof, (b) one, two or more of an aromatic dicarboxylic acid, an alicyclic dicarboxylic acid, and a derivative thereof, and (c) at least one, two or more of an aromatic diol, an alicyclic diol, an aliphatic diol, and a derivative thereof;
(3) a polyester amide composed mainly of (a) one, two or more of an aromatic hydroxycarboxylic acid and a derivative thereof, (b) one, two or more of an aromatic hydroxyamine, an aromatic diamine, and a derivative thereof, and (c) one, two or more of an aromatic dicarboxylic acid, alicyclic dicarboxylic acid, and a derivative thereof; and
(4) a polyester amide composed mainly of (a) one, two or more of an aromatic hydroxycarboxylic acid and a derivative thereof, (b) one, two or more of an aromatic hydroxyamine, an aromatic diamine, and a derivative thereof, (c) one, two or more of an aromatic dicarboxylic acid, alicyclic dicarboxylic acid, and a derivative thereof, and (d) at least one, two or more of an aromatic diol, an alicyclic diol, an aliphatic diol, and a derivative thereof. Furthermore, there may be added a molecular weight adjuster, if required, to the above structural components.

Preferred examples of the compound structuring the (D) liquid crystalline polymer applicable to the present invention are: aromatic hydroxycarboxylic acids such as p-hydroxybenzoic acid or 6-hydroxy-2-naphthoic acid; aromatic diols such as 2,6-dihydroxynaphthalene, 1,4-dihydroxynaphthalene, 4,4′-dihydroxybiphenyl, hydroquinone, resorcin, or compounds represented by the following formulae (I) and (II); aromatic dicarboxylic acids such as terephthalic acid, isophthalic acid, 4,4′-diphenyl dicarboxylic acid, 2,6-naphthalene dicarboxylic acid, or a compound represented by the following formula (III); and aromatic amines such as p-aminophenol or p-phenylene diamine.

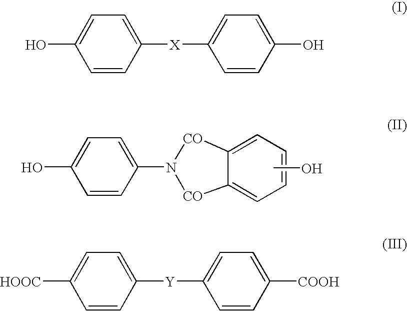

where: X is a group selected from an alkylene (C1-C4), an alkylidene, —O—, —SO—, SO₂—, —S—, and —CO—; and Y is a group selected from —(CH₂)ₙ—, (n=1 to 4), —O(CH₂)ₙO—, (n=1 to 4).

Specifically preferred (D) liquid crystalline polymer applied to the present invention includes an aromatic polyester and an aromatic polyester amide, containing p-hydroxybenzoic acid or 6-hydroxy-2-naphthoic acid as the main structural unit components.

The above (D) liquid crystalline polymers can be used either alone or in combination of two or more of them. If, however, the melting point of the liquid crystalline polymer is excessively high, a problem occurs in kneading with a PBT resin, or the like. For example, when the melting point of liquid crystalline polymer is significantly higher than the processing temperature of PBT resin, a good dispersity of the liquid crystalline polymer cannot be attained through the kneading thereof with a PBT resin at the processing temperature of the PBT resin. In addition, the increase in the processing temperature to obtain a good dispersion induces thermal decomposition of the PBT resin. Consequently, the melting point of liquid crystalline polymer is desired to be 320° C. or lower.

The additive amount of the (D) liquid crystalline polymer is within the range of 5 to 100 parts by weight to 100 parts by weight of the (A) PBT resin, preferably 10 to 50 parts by weight, and more preferably 10 to 30 parts by weight. If the additive amount of the (D) liquid crystalline polymer is smaller than 5 parts by weight, the improvement effect of GWIT becomes smaller. If the additive amount thereof is larger than 100 parts by weight, the characteristics as the PBT resin composition are lost.

### ((E) Inorganic Filler)

The resin composition used in the present invention preferably contains (E) an inorganic filler to improve the mechanical properties.

The (E) inorganic filler includes fibrous material, plate-like material, granular material, and a mixture of them. Examples of the (E) inorganic filler are known ones: fibrous material such as glass fiber, carbon fiber, silica-alumina fiber, zirconia fiber, metal fiber (such as stainless steel, aluminum, titanium, copper, or brass), and organic fiber (such as aromatic polyamide fiber or fluororesin fiber); a plate-like material such as glass flake, mica or talc, and/or a laminar silicate; and a granular material such as glass bead, carbon black or calcium carbonate. When the mechanical strength and the rigidity are emphasized, fibrous material, specifically glass fiber, is selected. When the decrease in anisotropy and warp of the product is emphasized, plate-like material, specifically mica, is selected.

These inorganic fillers can be used either alone or in combination of two or more of them, and a preferred inorganic filler is fibrous material, specifically glass fiber.

The mean fiber diameter of the fibrous reinforcement is not specifically limited and is, for example, within the range of 1 to 100 μm, preferably 1 to 50 μm, and more preferably about 3 to 30 μm. The mean fiber length of the fibrous reinforcement is also not specifically limited and is, for example, within the range of about 0.1 to 20 mm.

The additive amount of the (E) inorganic filler is, for example, within the range of 0 to 200 parts by weight to 100 parts by weight of the (A) PBT resin, and the additive amount thereof may be determined depending on the level of required rigidity and dimensional stability. Normally the additive amount thereof is within the range of 5 to 120 parts by weight, and preferably from 30 to 100 parts by weight. If the additive amount of the (E) inorganic filler is larger than 200 parts by weight, the melt-kneading properties and the moldability deteriorate, which is not preferable.

The inorganic filler may be subjected to surface treatment, at need, using a converging agent or a surface-treating agent (for example, a functional compound such as an epoxy-based compound, an isocyanate-based compound, a silane-based compound, or a titanate-based compound). The inorganic filler may be preliminarily subjected to surface treatment by the converging agent or the surface-treating agent, or may be subjected to surface treatment by adding the converging agent or the surface treating agent when the resin composition is prepared.

To the PBT resin composition according to the present invention, it is preferable to add a compound of one or more of a triazine compound, a phosphinic acid salt, and a diphosphinic acid salt as the (F) component to further improve GWIT.

The triazine compounds include melamine, melamine cyanurate, melam, melem, and mellon. Flame retardancy can be imparted to the triazine compounds owing to the effects of: cooling the combustion system by an endothermic reaction through the sublimation and the decomposition at the time of combustion; insulating by nitrogen gas and the like generated at the time of decomposition; and dilution of combustion components.

The phosphinic acid salt used in the present invention is, for example, the one represented by the following formula (1), and the diphosphinic acid salt used therein is, for example, the one represented by the following formula (2). Polymers of them can also be used.

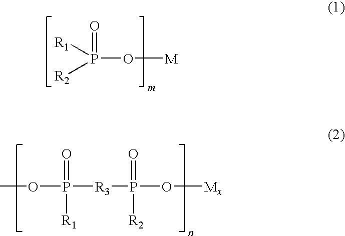

where, R₁ and R₂ are each straight-chain or branched chain C1 to C6 alkyl or phenyl, R₃ is a straight-chain or branched chain C1 to C10 alkylene, arylene, alkylarylene, or arylalkylene, M is calcium ion or aluminum ion, m is 2 or 3, n is 1 or 3, and x is 1 or 2.

As of these compounds, metal salts such as dimethyl phosphinic acid salt, ethylmethyl phosphinic acid salt, diethyl phosphinic acid salt or methylphenyl phosphinic acid salt can preferably be used, and further preferred one is a metal salt of diethyl phosphinic acid salt. According to the present invention, one, two or more of these compounds are used.

The additive amount of the (F) component is within the range of 1 to 100 parts by weight to 100 parts by weight of the (A) PBT resin, preferably 1 to 80 parts by weight, more preferably 1 to 60 parts by weight, and most preferably 5 to 50 parts by weight. If the additive amount of the (F) component is smaller than 1 part by weight, the improvement effect of GWIT becomes small. If the additive amount thereof is larger than 100 parts by weight, mechanical properties may deteriorate.

Depending on the uses of the molded products, there may be requested the “V-O” flame classification specified by the UL Standard. In such cases, it is preferable to use an anti-dropping agent such as fluorine-based resin together with the flame retardant.

The fluorine-based resins include: homopolymers or copolymers of fluorine-containing monomers such as tetrafluoroethylene, chlorotrifluoroethylene, vinylidene fluoride, hexafluoropropylene, or perfluoroalkylvinylether; or copolymers of the above-described fluorine-containing monomers with copolymerizable monomers such as ethylene, propylene, or (meth)acrylate.

Examples of such types of fluorine-based resins are: homopolymers such as polytetrafluoroethylene, polychlorotrifluoroethylene, polyvinylidene fluoride, and the like; copolymers such as tetrafluoroethylene-hexafluoropropylene copolymer, a tetrafluoroethylene-perfluoroalkylvinylether copolymer, an ethylene-tetrafluoroethylene copolymer, or an ethylene-chlorotrifluoroethylene copolymer. These fluorine-based resins can be used either alone or in combination of two or more of them. These fluorine-based resins can be used in the form of dispersion.

The additive amount of the fluorine-based resin is, for example, 0 to 10 parts by weight to 100 parts by weight of the (A) PBT resin, preferably 0.1 to 5 parts by weight, and more preferably about 0.2 to 1.5 parts by weight.

Furthermore, to the resin composition according to the present invention, there may be added, if required, common additives such as a stabilizer including antioxidant, UV absorber, thermal stabilizer, or weather stabilizer, and further a lubricator, a mold-releasing agent, a coloring agent, a crystal nucleating agent, and a crystallization-enhancing agent. Furthermore, other thermoplastic resins (such as polyamide or acrylic resin) and thermosetting resins (such as unsaturated PBT resin, phenol resin, or epoxy resin) may be added.

The PBT resin composition according to the present invention may be in the form of a mixture of powder and granule or in the form of a molten mixture, and the PBT resin composition can be prepared by blending the (A) PBT resin, the (B) halogen-based flame retardant, the (C) flame retardant assistant, the (D) liquid crystalline polymer, and if required, the (E) inorganic filler, the (F) one or more compounds selected from a triazine compound, a phosphinic acid salt, and a diphosphinic acid salt, a fluorine-based resin, and other additives by an ordinary method. For example, individual components are mixed together, and the mixture obtained is then kneaded in and extruded from a single-screw or twin-screw extruder to obtain the pellets of PBT resin composition. In this case, it is preferable that the melting-kneading be conducted at the melting point of the liquid crystalline polymer or higher, and that good dispersion of the liquid crystalline polymer be attained in the PBT resin. The insulating material parts of the present invention can be obtained by using the PBT resin composition prepared by the above method, and then by molding the composition using a known molding method such as injection molding.

### EXAMPLES

The present invention is described in more detail in reference to examples. The present invention, however, is not limited to these examples.

### Examples 1 to 7, Comparative Examples 1 to 3

As shown in Table 1, the respective amounts of (B), (C), (D), and (F) components were added to 100 parts by weight of the (A) PBT resin, which mixture was then homogeneously mixed in a V-blender. Thus obtained mixture was charged into a hopper of twin-screw extruder (manufactured by Japan Steel Works, Ltd.). A specified amount of the (E) glass fiber was supplied to the extruder through a side feed opening. The mixture was melted and kneaded at 280° C. of barrel temperature. The strand discharged from the die was cooled and cut to prepare the pellet-shaped composition. The prepared pellets were dried at 140° C. for 3 hours, which were then molded in an injection molding machine (manufactured by FANUC LTD.) under the condition of 260° C. of cylinder temperature and 80° C. of mold temperature, and thus specified molded article for varieties of tests was obtained. With the molded article for test, various physical properties described below were evaluated. The result is given in Table 1.

### (1) GWIT Evaluation

Each of the evaluation test pieces (flat plate of 8 cm×8 cm×3 mm in thickness, flat plate of 8 cm×8 cm×1.5 mm in thickness, and flat plate of 6 cm×6 cm×0.75 mm in thickness) was evaluated by the test method specified by IEC60695-2-13. That is, a glow-wire of predetermined shape (looped nickel-chromium (80/20) wire having an outer diameter of 4 mm) was brought into contact with the test pieces for 30 seconds, and the maximum temperature at the tip of the glow-wire when the test pieces are not ignited or the spread of flame to the test pieces is prevented for 5 seconds or longer, was measured. GWIT was defined as the temperature 25° C. higher than the measured maximum temperature. For the uses of flame retardant specified in the Standard, GWIT of 775° C. or above is required.

### (2) GWFI Evaluation

For the above test pieces, the evaluation was conducted by the test method specified in IEC60695-2-12. That is, a glow-wire of predetermined shape (looped nickel-chromium (80/20) wire having an outer diameter of 4 mm) was brought into contact with the test pieces for 30 seconds, and then the glow-wire was separated from the test pieces. There was measured the maximum temperature at the tip of the glow-wire when the test pieces are not ignited during the separating action or the flame is extinguished within 30 seconds after the separation even if ignited. GWFI was defined as the measured maximum temperature. For the uses of flame retardant, GWFI of 850° C. or above is required.

### (3) Flame Retardancy Test

A test piece ( 1/32 inch in thickness) was tested by the vertical position flammability test specified by UL-94 Standard of Underwriter's Laboratories Inc.

### (4) Tensile Test

Tensile strength and tensile elongation were determined for a dumbbell test piece (4 mm in thickness) specified by ISO294, in accordance with ISO527.

The details of each component used in Examples and Comparative Examples are as follows.

(A) PBT resin

Intrinsic viscosity 0.7 g/dl, manufactured by WinTech Polymer Ltd.

(B) Halogen-based flame retardant

(B-1) Polypentabromobenzyl acrylate (FR1025, manufactured by Bromchem Far East Co., Ltd.)

(B-2) Ethylenebistetrabromophthalimide (SAYTEX BT93W, manufactured by Albemarle Corporation)

(B-3) Brominated polystyrene (PDBS-80M GLC, manufactured by Great Lakes Chemical Corporation)

(C) Flame retardant assistant
Antimony trioxide (PATOX-M, manufactured by Nihon Seiko Co., Ltd.)
(D) Liquid crystalline polymer (A950 (melting point: 280° C.), manufactured by Polyplastics Co., Ltd.)
(E) Inorganic filler
Glass fiber (ECSO3T-127, 10 mm in diameter, manufactured by Nippon Electric Glass Co., Ltd.)

### (F) Component

(F-1) Aluminum salt of 1,2-diethylphosphinic acid

The (F) component was prepared by the following procedure.

A 2106 g (19.5 mole) of diethylphosphinic acid was dissolved in 6.5 liter of water. To the mixture, 507 g (6.5 mole) of aluminum hydroxide was added while vigorously agitating the mixture. The mixture was heated to 85° C. After agitating the mixture at temperatures ranging from 80° C. to 90° C. for 65 hours, the mixture was cooled to 60° C., and then it was then filtered by suction. The cake was dried in a vacuum drying cabinet at 120° C. until the mass became constant, and thus 2140 g of fine powder which was not melted at 300° C. or lower temperature was obtained. The yield was 95% of the theoretical value.

(F-2) Melamine cyanurate (Hostaflon TF1620, manufactured by Nissan Chemical Industries, Ltd.)

Anti-dropping agent: Tetrafluoroethylene resin (Hostaflon TF1620, manufactured by Hoechst Industry Ltd.)

TABLE 1

| | Examples | | | | | | | Comparative Examples | | |
|---|---|---|---|---|---|---|---|---|---|---|
| | 1 | 2 | 3 | 4 | 5 | 6 | 7 | 1 | 2 | 3 |
| (A) PBT (parts by weight) | 100 | 100 | 100 | 100 | 100 | 100 | 100 | 100 | 100 | 100 |
| (B-1) Bromine-based flame retardant | 24 | | | 28 | 27 | 28 | 34 | 21 | | |
| (parts by weight) | | | | | | | | | | |
| (B-2) Bromine-based flame retardant | | 22 | | | | | | | 19 | |
| (parts by weight) | | | | | | | | | | |
| (B-3) Bromine-based flame retardant | | | 24 | | | | | | | 21 |
| (parts by weight) | | | | | | | | | | |
| (C) Antimony trioxide | 18 | 18 | 18 | 21 | 21 | 21 | 26 | 16 | 16 | 16 |
| (parts by weight) | | | | | | | | | | |
| (D) Liquid crystalline polymer | 14 | 14 | 14 | 17 | 16 | 17 | 21 | | | |
| (parts by weight) | | | | | | | | | | |
| (E) Glass fiber | 67 | 67 | 67 | 79 | 77 | 80 | 96 | 59 | 58 | 59 |
| (parts by weight) | | | | | | | | | | |
| (F-1) Diethylphosphinate | | | | | | 19 | 22 | | | |
| (parts by weight) | | | | | | | | | | |
| (F-2) Triazine compound | | | | 17 | 26 | | 21 | | | |
| (parts by weight) | | | | | | | | | | |
| Anti-dropping agent | 1 | 1 | 1 | 1 | 1 | 1 | 1 | 1 | 1 | 1 |
| (parts by weight) | | | | | | | | | | |
| GWIT 3 mmt (° C.) | 775 | 775 | 775 | 825 | 825 | 825 | 825 | 725 | 750 | 725 |
| GWIT 1.5 mmt (° C.) | 725 | 725 | 725 | 750 | 775 | 775 | 800 | 700 | 700 | 700 |
| GWIT 0.75 mmt (° C.) | 800 | 775 | 800 | 850 | 875 | 850 | 850 | 750 | 725 | 750 |
| GWFI 3 mmt (° C.) | 960 | 960 | 960 | 960 | 960 | 960 | 960 | 960 | 960 | 960 |
| GWFI 1.5 mmt (° C.) | 960 | 960 | 960 | 960 | 960 | 960 | 960 | 960 | 960 | 960 |
| GWFI 0.75 mmt (° C.) | 960 | 960 | 960 | 960 | 960 | 960 | 960 | 960 | 960 | 960 |
| Flame retardancy UL-94 | V-0 | V-0 | V-0 | V-0 | V-1 | V-0 | V-0 | V-0 | V-0 | V-0 |
| Tensile strength (MPa) | 144 | 123 | 128 | 123 | 135 | 123 | 112 | 148 | 127 | 135 |
| Tensile elongation (%) | 1.9 | 1.7 | 1.4 | 1.3 | 1.6 | 1.4 | 1.2 | 2.0 | 2.0 | 1.6 |

As shown in Table 1, the combined addition of a halogen-based flame retardant and a liquid crystalline polymer to the PBT resin allows the attainment of 775° C. or higher of glow-wire ignition temperature specified in IEC60695-2-13 for both the test piece thicknesses of 0.75 mm and 3 mm (Examples 1 to 4). In addition, the combined use of a triazine compound and a phosphinic acid salt allows the attainment of 775° C. or higher of GWIT, specified by IEC, over a wide thickness range of 0.75 mm to 3 mm, which is recommended by IEC.

Furthermore, as is clear from the comparison between Examples 1 to 3 and Comparative Examples 1 to 3, the present invention improves the effect on GWIT with very little deterioration in physical properties.

From these reasons, the electrical safety can be improved by applying the flame retardant PBT resin according to the present invention to the part which supports a connection section carrying an electric current exceeding 0.2 A during operations, or the part located within 3 mm from the connection section (printed circuit board, terminal block, plug, and the like), among the PBT products which work without operator.

1. A flame retardant polybutylene terephthalate resin composition comprising: (A) 100 parts by weight of a polybutylene terephthalate resin; (B) 5 to 50 parts by weight of a halogen-based flame retardant; (C) 5 to 40 parts by weight of a flame retardant assistant; (D) 5 to 100 parts by weight of a liquid crystalline polymer; and (E) 0 to 200 parts by weight of an inorganic filler.

2. The flame retardant polybutylene terephthalate resin composition according to claim 1, wherein the (B) halogen-based flame retardant is a halogenated aromatic bisimide compound, a halogenated benzyl acrylate, or a halogenated polystyrene compound.

3. The flame retardant polybutylene terephthalate resin composition according to claim 1, wherein the (D) liquid crystalline polymer has a melting point of 320° C. or lower.

4. The flame retardant polybutylene terephthalate resin composition according to claim 1, further comprising (F) 1 to 100 parts by weight of one or more compounds selected from the group consisting of a triazine compound, a phosphinic acid salt, and a diphosphinic acid salt to 100 parts by weight of the (A) component.

5. The flame retardant polybutylene terephthalate resin composition according to claim 1, satisfying the condition that a glow-wire ignition temperature specified by IEC60695-2-13 is 775° C. or higher at all of test-piece's thicknesses of 0.75 mm, 1.5 mm, and 3 mm.

6. An insulating material part composed of the flame retardant polybutylene terephthalate resin composition according to claim 1.

7. The flame retardant polybutylene terephthalate resin composition according to claim 2, wherein the (D) liquid crystalline polymer has a melting point of 320° C. or lower.

8. The flame retardant polybutylene terephthalate resin composition according to claim 2, further comprising (F) 1 to 100 parts by weight of one or more compounds selected from the group consisting of a triazine compound, a phosphinic acid salt, and a diphosphinic acid salt to 100 parts by weight of the (A) component.

9. The flame retardant polybutylene terephthalate resin composition according to claim 3, further comprising (F) 1 to 100 parts by weight of one or more compounds selected from the group consisting of a triazine compound, a phosphinic acid salt, and a diphosphinic acid salt to 100 parts by weight of the (A) component.

10. The flame retardant polybutylene terephthalate resin composition according to claim 7, further comprising (F) 1 to 100 parts by weight of one or more compounds selected from the group consisting of a triazine compound, a phosphinic acid salt, and a diphosphinic acid salt to 100 parts by weight of the (A) component.

11. The flame retardant polybutylene terephthalate resin composition according to claim 2, satisfying the condition that a glow-wire ignition temperature specified by IEC60695-2-13 is 775° C. or higher at all of test-piece's thicknesses of 0.75 mm, 1.5 mm, and 3 mm.

12. The flame retardant polybutylene terephthalate resin composition according to claim 3, satisfying the condition that a glow-wire ignition temperature specified by IEC60695-2-13 is 775° C. or higher at all of test-piece's thicknesses of 0.75 mm, 1.5 mm, and 3 mm.

13. The flame retardant polybutylene terephthalate resin composition according to claim 4, satisfying the condition that a glow-wire ignition temperature specified by IEC60695-2-13 is 775° C. or higher at all of test-piece's thicknesses of 0.75 mm, 1.5 mm, and 3 mm.

14. The flame retardant polybutylene terephthalate resin composition according to claim 7, satisfying the condition that a glow-wire ignition temperature specified by IEC60695-2-13 is 775° C. or higher at all of test-piece's thicknesses of 0.75 mm, 1.5 mm, and 3 mm.

15. The flame retardant polybutylene terephthalate resin composition according to claim 8, satisfying the condition that a glow-wire ignition temperature specified by IEC60695-2-13 is 775° C. or higher at all of test-piece's thicknesses of 0.75 mm, 1.5 mm, and 3 mm.

16. The flame retardant polybutylene terephthalate resin composition according to claim 9, satisfying the condition that a glow-wire ignition temperature specified by IEC60695-2-13 is 775° C. or higher at all of test-piece's thicknesses of 0.75 mm, 1.5 mm, and 3 mm.

17. An insulating material part composed of the flame retardant polybutylene terephthalate resin composition according to claim 2.

18. An insulating material part composed of the flame retardant polybutylene terephthalate resin composition according to claim 3.

19. An insulating material part composed of the flame retardant polybutylene terephthalate resin composition according to claim 4.

20. An insulating material part composed of the flame retardant polybutylene terephthalate resin composition according to claim 5.
